(19) United States
(12) Patent Application Publication
(10) Pub. No.: US 2010/0175948 A1
(43) Pub. Date: Jul. 15, 2010

(54) HYDRAULIC ACTUATING CIRCUIT FOR POWER-ASSISTED STEERING, AND MOTOR VEHICLE EQUIPPED THEREWITH

(75) Inventor: Didier Martinez, Saint-Etienne-sous-bailleul, (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne- Billancourt (FR)

(21) Appl. No.: 12/666,471

(22) PCT Filed: May 19, 2008
(86) PCT No.: PCT/FR08/50861

§ 371 Date: Mar. 23, 2010

(30) Foreign Application Priority Data
Jun. 27, 2007 (FR) 0704605

(51) Int. Cl. B62D 5/09

(52) U.S. Cl. 180/442

(57) ABSTRACT

A power-steering hydraulic actuating circuit for a motor vehicle, including a hydraulic fluid distributing valve including hydraulic fluid supply ports connected to a pump via lines. A mechanism restricts the cross section of hydraulic fluid flow from the pump to the port and is provided on the high-pressure line.

The invention relates to a hydraulic actuating circuit for power-assisted steering for a motor vehicle.

One area of application of the invention is steering systems for a motor vehicle, assisted hydraulically to help in maneuvering its guiding wheels by means of the steering wheel turned by the user.

The motor vehicle is usually provided with a steering column actuated by the steering wheel, which is supposed to translationally displace by engagement a rack connected mechanically to the wheels, so as to turn them in the desired direction.

For power assistance, the rotation of the steering column acts via a bar on a distributing hydraulic valve. This valve is in hydraulic communication with a power-assistance cylinder that moves integrally in translation with the rack, so as to develop thereon a supplementary force acting in the same direction as the rotation of the steering column.

It happens that the steering system is disturbed during turning maneuvers by a vibration or undulation phenomenon (in English: ripple), which creates an instability felt by the user.

This phenomenon appears in particular in the course of parking maneuvers on certain adhesions to the ground.

In the state of the art, it is sometimes considered, without any technical solution being proposed, that problems indeed exist but that the ripple is acceptable for the user.

In other cases, attempts are made to reduce the ripple by making modifications to the hydraulic line, by adding and/or removing flexible and/or rigid parts of the hoses, without specific methodology. Of course, that brings about non-negligible development time.

The purpose of the invention is to provide a hydraulic actuating circuit for power-assisted steering that alleviates the disadvantages of the state of the art and effectively reduces this phenomenon of instability in turning.

To this end a first object of the invention is a hydraulic actuating circuit for power-assisted steering for a motor vehicle, the circuit being provided with at least one steering-control inlet and at least one hydraulic-fluid outlet, the outlet being intended to apply a hydraulic-fluid pressure to a hydraulic cylinder for power-assisted steering in order to actuate a vehicle steering train in communication with the cylinder as a function of a steering control signal received at the inlet,

the circuit being provided with:

a pressurized hydraulic-fluid supply pump,

at least one first high-pressure hydraulic-fluid line and at least one second hydraulic-fluid line,

a hydraulic-fluid distributing valve, provided with first and second hydraulic-fluid supply ports in communication with the pump via the first and second lines respectively, and at least one supplementary port, which is in communication with the outlet, the valve being provided, between the supplementary port and the first or second port, with a hydraulic-fluid passage cross section that is variable as a function of the control signal present at the inlet,

characterized in that

a means for restricting the hydraulic-fluid passage cross section of the pump toward the first port is provided on the first high-pressure line.

According to other characteristics of the invention,

The restricting means is formed by a localized element for restricting the passage cross section of the first high-pressure line upstream from the first port of the valve; the first high-pressure line comprises a flexible hydraulic-fluid hose having an expansion volume larger than a stipulated value between the restricting element and the pump.

The restricting element is interposed between the outlet end of the first high-pressure line, distant from the pump, and the first port of the valve.

For a steering train having a dynamic whose first order corresponds to a first anti-symmetric train mode, with a given specific frequency, the restricting means is chosen such that the transfer function of the outlet pressure relative to the control signal at the inlet has a total phase shift of less than 20° in absolute value at this natural frequency of the first anti-symmetric mode of the train.

For a steering train having a dynamic whose first order corresponds to a first anti-symmetric mode of the train, which mode has a definite natural frequency, the restricting means adds for this natural frequency of the first anti-symmetric mode of the train a positive value to the phase shift of the transfer function of the outlet pressure relative to the control signal at the inlet.

The added positive value of phase shift of the restricting means is greater than or equal to 60° at this specific frequency of the first anti-symmetric train mode.

For a steering train having a dynamic whose first order corresponds to a first anti-symmetric train mode, with a given specific frequency, the restricting means is chosen such that the transfer function of the outlet pressure relative to the control signal at the inlet has a zero whose frequency is below this specific frequency of the first anti-symmetric train mode.

The frequency of the zero of the transfer function is equal to one third of the specific frequency of the first anti-symmetric train mode.

For a double-acting cylinder, a first outlet is provided in order to apply a hydraulic-fluid pressure on a first side of a piston of the cylinder and a second outlet is provided in order to apply a hydraulic-fluid pressure on a second side of a piston of the cylinder opposite the first side,

the valve is provided with:

a third port in communication with the first outlet,

a fourth port in communication with the second outlet,

a first branch for passage of hydraulic fluid, associated with a first passage cross-section restriction between the third port and the first port,

a second branch for passage of hydraulic fluid, associated with a second passage cross-section restriction between the third port and the second port,

a third branch for passage of hydraulic fluid, associated with a third passage cross-section restriction between the fourth port and the first port,

a fourth branch for passage of hydraulic fluid, associated with a fourth passage cross-section restriction between the fourth port and the second port,

the hydraulic-fluid passage cross section of the first and fourth restrictions or the hydraulic-fluid passage cross section of the second and third restrictions being a function of the control signal present at the inlet.

Another object of the invention is a motor vehicle, provided with a steering wheel connected via a steering column to a rack for controlling the displacement of the rack connected to a steering train in such a way as to orient the guiding wheels connected to this train,

the rack being connected to at least one hydraulic cylinder for assisting the displacement of the rack,

the vehicle being equipped with a hydraulic circuit for actuating the power-assisted steering according to any one of the preceding claims,

a means being provided to apply, as a function of the rotation of the steering column, a steering control signal at the inlet of the hydraulic circuit for actuating the power-assisted steering,

the cylinder being in communication with the outlet of the hydraulic actuating circuit in order to receive therefrom a hydraulic-fluid pressure for actuating the cylinder with a view to displacing the rack according to the steering control signal.

The invention will be better understood by reading the description hereinafter, provided solely by way of non-limitative example in reference to the attached drawings, wherein:

FIG. 1 shows a modular block diagram of a motor-vehicle power-assisted steering system actuated by a hydraulic circuit according to the invention,

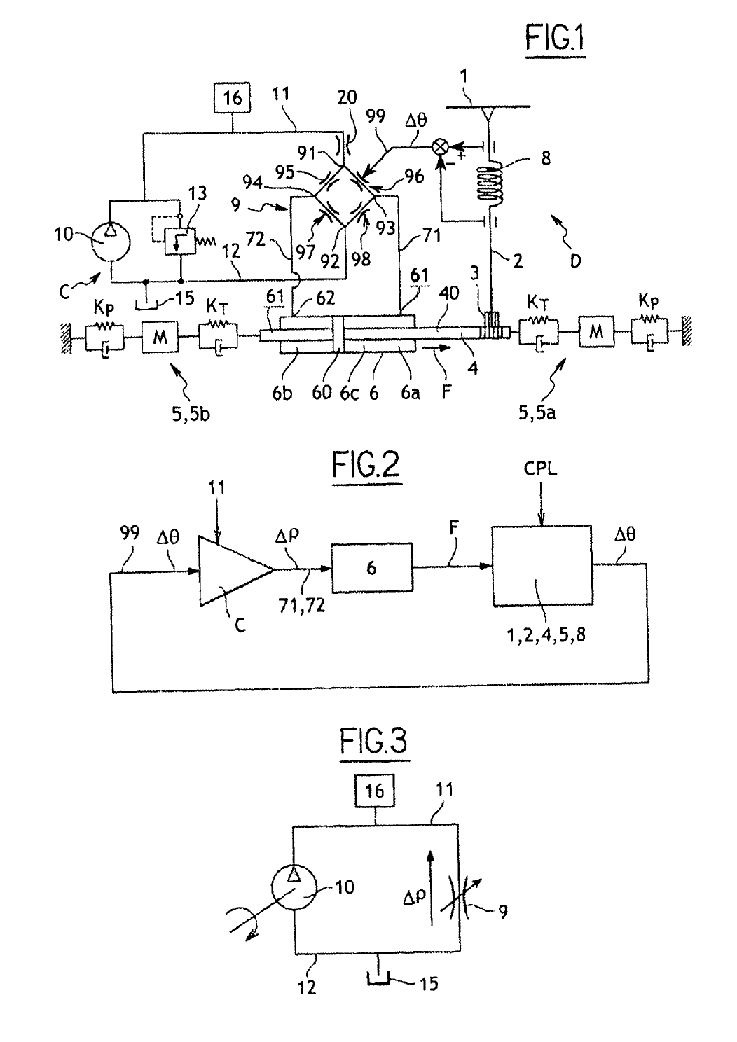

FIG. 2 shows an equivalent diagram of the power-assisted steering system and of its hydraulic actuating circuit according to the invention,

FIG. 3 is an equivalent diagram of a hydraulic actuating circuit according to the state of the art for a power-assisted steering system,

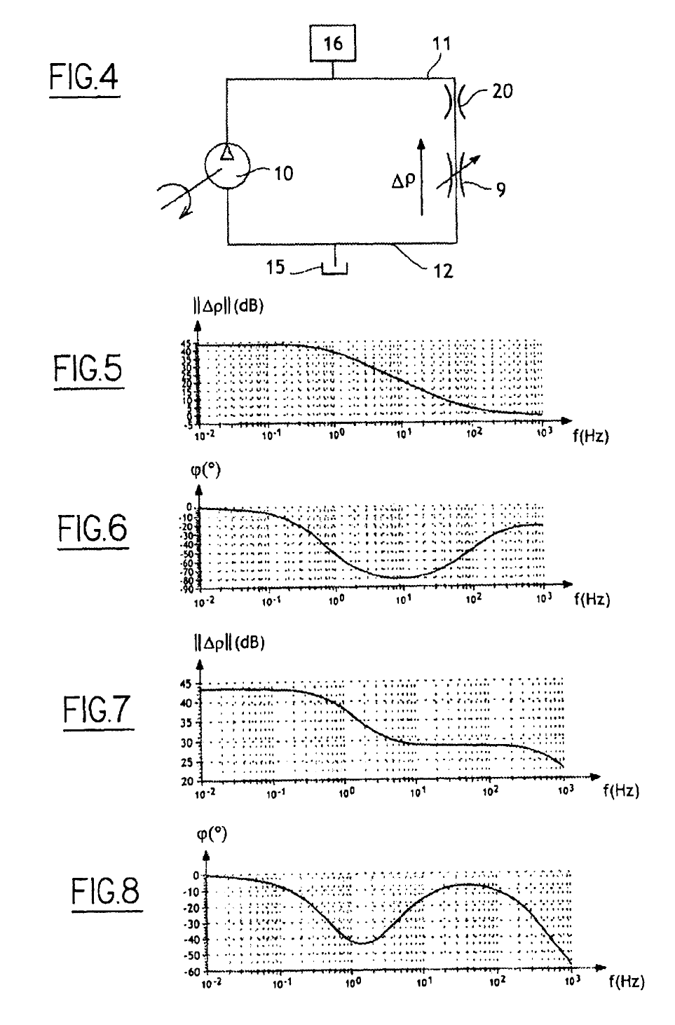

FIG. 4 is an equivalent diagram of a hydraulic actuating circuit according to the invention for a power-assisted steering system,

FIG. 5 is a diagram showing on the ordinate the module of the transfer function of the outlet of the hydraulic actuating circuit in dB on the ordinate according to the frequency in hertz on the abscissa, in the state of the art according to FIG. 3,

FIG. 6 is a diagram showing on the ordinate the phase of the transfer function of the outlet of the hydraulic actuating circuit in degrees on the ordinate according to the frequency in hertz on the abscissa, in the state of the art according to FIG. 3,

FIG. 7 is a diagram showing on the ordinate the module of the transfer function of the outlet of the hydraulic actuating circuit in dB on the ordinate according to the frequency in hertz on the abscissa, in an exemplary embodiment of the invention,

FIG. 8 is a diagram showing on the ordinate the phase of the transfer function of the outlet of the hydraulic actuating circuit in degrees on the ordinate according to the frequency in hertz on the abscissa, in an exemplary embodiment of the invention.

In FIG. 1, the motor vehicle is provided with a steering wheel 1 for turning a steering column 2 engaging at its end 3 with a rack 4 constituting part of steering train 5 of the vehicle. This steering train 5 assures that the guiding wheels of the vehicle, which are usually the two right and left wheels thereof on its front axle, are connected to the ground. This steering train 5 is usually provided on each of the two right and left sides with a half-train 5a, 5b provided with the following elements connected mechanically with each other: a lower arm constituted by a lower triangle, a steering knuckle for rolling of the wheel, a shock absorber, the lower arm being connected to the vehicle body by elastic connections, as is known.

To turn the wheels, rack 4 must be laterally displaced in translation in the width direction of the vehicle, or in other words toward the right or left. To accomplish this, given that the turning torque CPL capable of being applied by the user to column 2 via steering wheel 1 may be relatively small, a cylinder 6 is fixed to rack 4 to aid its translational displacement in the direction corresponding to rotation of column 2 toward the right or toward the left. Cylinder 6, for example, is formed by a double-acting cylinder, provided with a piston 60 integral with a rod 61, which is connected to rack 4 by a fixation point 40 and which can be displaced toward the right and toward the left in a fixed barrel 6c, depending on whether a greater hydraulic-fluid pressure is present on its opposite left or right side. Cylinder 6 is provided with a first right hydraulic chamber 6a, which can be supplied, via a connection 61, with hydraulic fluid by a first outlet 71 to apply a force on the first right side of piston 60, as well as with a second left hydraulic chamber 6b, which can be supplied, via a second connection 62, with hydraulic fluid by a second outlet 72 to apply a force on the second left side of piston 60, opposite its first right side, outlets 71, 72 being formed, for example, by ducts.

Via a bar 8, steering column 2 also actuates a valve 9 for distributing hydraulic fluid between first and second outlets 71, 72. Valve 9 is provided with a first port 91 in communication with the high-pressure side of a hydraulic-fluid pump 10 via a first high-pressure line 11, a second port 92 in communication with the low-pressure side of pump 10 via a second low-pressure hydraulic line 12, a hydraulic-fluid port 93 in communication with first connection 61 via first outlet 71 and a hydraulic-fluid port 94 in communication with second connection 62 via second outlet 72. Pump 10 is in communication via its low-pressure side with a hydraulic-fluid reservoir 15. Pump 10 is associated with a pressure limiter 13. Hydraulic pump 10 is positively connected, meaning that it is belt-driven by the internal combustion engine of the motor vehicle. Valve 9 is provided with:
between ports 91 and 94, a hydraulic-fluid passage branch associated with a passage cross-section restriction 95,
between ports 91 and 93, a hydraulic-fluid passage branch associated with a hydraulic-fluid passage cross-section restriction 96,
between ports 94 and 92, a hydraulic-fluid passage branch associated with a hydraulic-fluid passage cross-section restriction 97,
between ports 93 and 92, a hydraulic-fluid passage branch associated with a hydraulic-fluid passage cross-section restriction 98.

In valve 9, restrictions 96 and 97 situated on the opposite branches are controlled in the same way from a control inlet 99. Furthermore, the other two restrictions 95 and 98 vary in identical manner. The hydraulic-fluid pressure at outlet 71, 72 is variable as a function of the control signal present at inlet 99. The passage cross sections of restrictions 96 and 97 are directly a function of the angular displacement generated by torsion bar 8. This displacement represents an angular offset between the casing and plug of valve 9. Control inlet 99 is formed by the torsion bar of valve 9 in such a way as to vary the passage cross section between supplementary port 93, 94 and first or second port 91, 92.

In this way, when the control signal applied to control inlet 99 connected to torsion bar 8 brings about a smaller hydraulic-fluid passage cross section in restrictions 95 and 98 than in the other two restrictions 96 and 97 of valve 9, a higher hydraulic-fluid pressure is sent from port 91 to first outlet 71 than to second outlet 72, which causes displacement of piston 60 and of cylinder rod 6 toward the left part 5b of train 5.

On the other hand, when the control signal applied to control inlet 99 by bar 8 makes the hydraulic-fluid passage cross section in restrictions 95 and 98 larger than those of the other two restrictions 96 and 97, a lower hydraulic-fluid pressure is sent from high-pressure port 91 to first outlet 71 than to second outlet 72, which causes displacement of piston 60 and of cylinder rod 6 toward the right part 5a of train 5.

In FIG. 1, control inlet 99 of valve 9 receives as control signal the angular offset Δθ of bar 8 between the plug, represented by the − sign, and the casing, represented by the + sign, of valve 9.

FIG. 2 shows that the production of the assisting force by cylinder 6 results from feedback between the mechanical system (steering wheel 1, steering column 2, rack 4, train 5, torsion bar 8 and torque CPL applied by the driver to steering wheel 1) and hydraulic circuit C, represented in the form of a hydraulic amplifier. This hydraulic amplifier transforms the control signal Δθ applied to control inlet 99 into a pressure difference ΔP between outlets 71 and 72.

As it happens, the ripple phenomenon results in local instability caused by the dynamic behavior of train 5. The dynamic of train 5, represented in the first order by its first anti-symmetric train mode, may actually become unstable by coupling, caused by the counter-reaction of the hydraulic amplifier. This instability generates oscillations in the wheels connected to train 5 and in steering column 2. The user then feels these instabilities on steering wheel 1.

Train 5 of the guiding wheels has a symmetric resonance mode, in which a disturbance directed in the longitudinal direction of the vehicle between the front and rear causes the guiding wheels to vibrate in phase, and a first anti-symmetric resonance mode, in which a disturbance in the longitudinal direction of the vehicle causes the guiding wheels to vibrate in phase opposition. It is in this anti-symmetric train mode that the disturbing vibration of the guiding wheels is transmitted by rack 4 to steering column 2 and to steering wheel 1, at a given specific frequency fₜᵣₐᵢₙ. This standard frequency fₜᵣₐᵢₙ of the first anti-symmetric train mode is usually equal to 20 Hz. In the symmetric mode, train 5 has on each half-train 5a, 5b, a lateral train stiffness kT and a lateral pneumatic stiffness kP, with a mass M corresponding to the mobile part of the train perceived by rack 4.

According to the invention, these instabilities are reduced by adapting the frequency response of the hydraulic amplifier.

In the absence of the invention, hydraulic amplifier C may be modeled according to FIG. 3.

High-pressure line 11 comprises a flexible hydraulic-fluid hose. The dynamic behavior of hydraulic amplifier C is then as follows:

$$Δ P = K ( α ) \frac{Δ {P}_{0}}{s + \frac{K ( {α}_{0} )}{k}}$$

with

ΔP: Pressure difference between chambers 6a and 6b,

K(α): Value of the equivalent restriction of the valve around the operating point,

K(α₀): Value of the equivalent restriction of the valve at the operating point,

k: Total expansion of the flexible hoses of high-pressure line 11, indicated by reference mark 16 in the figures,

ΔP₀: Pressure constant.

The behavior is of the low-pass, first-order type (20 dBb/decade, phase shift of −90°). The cutoff pulsation of the filter is given by ω_{c0}=

$$\frac{K ( {α}_{0} )}{k} .$$

It is a function of the current point. From the stability viewpoint, the most critical case, when the behavior of this filter is integrated into the feedback loop, corresponds to a static gain and a cutoff frequency such that, at the specific frequency fₜᵣₐᵢₙ of the anti-symmetric train mode, this gain is larger than 1 and the phase shift is maximal (in other words, close to −90° for this type of filter). At this instant the risk of instability will be maximal. If instability occurs, the phenomenon will be felt by the user as an oscillation of the steering wheel with a frequency close to that of the anti-symmetric train mode.

In FIGS. 1 and 4, the invention provides for the introduction of a means 20 for restricting the hydraulic-fluid passage cross section in high-pressure line 11 between pump 10 and first port 91 of distributing valve 9. Restriction 20 is calibrated at a given value.

The dynamic behavior of the hydraulic amplifier is then modified according to the following transfer function between outlets 71, 72 and inlet 99:

$$Δ P = K ( α ) \frac{Δ {P}_{0} ( ks + {K}_{r} )}{k [ K ( {α}_{0} ) + {K}_{r} ] s + K ( {α}_{0} ) {K}_{r}}$$

where Kᵣ is the value of the supplementary restriction of hydraulic-fluid passage cross section of means 20 in high-pressure line 11 between pump 10 and first port 91 of distributing valve 9.

This behavior is that of a phase-delay filter whose cutoff frequencies are given by:

for the zero:

$${ω}_{z 1} = \frac{{K}_{r}}{k}$$

and for the pole:

$${ω}_{p 1} = \frac{{K}^{′}}{k} with {K}^{′} = \frac{K ( {α}_{0} ) {K}_{r}}{K ( {α}_{0} ) + {K}_{r}}$$

The advantage of this structure is the possibility of choosing the restriction Kᵣ such that the hydraulic amplifier no longer phase shifts to frequencies close to that fₜᵣₐᵢₙ of the anti-symmetric train mode. For that purpose it is possible, for example, to choose:

$${ω}_{z 1} = \frac{{ω}_{train}}{3} ,$$

or in other words

$${K}_{r} = k * \frac{{ω}_{train}}{3} ,$$

where ωₜᵣₐᵢₙ=2.Π.fₜᵣₐᵢₙ

In FIGS. 5 to 8, ∥ΔP∥ represents the module of the transfer function of hydraulic amplifier C, φ denotes the phase of this transfer function and f denotes the frequency.

FIGS. 5 and 6 show the case of a hydraulic circuit according to the state of the art, in which the mean value of ΔP is 40 bar. In FIGS. 5 and 6, when the frequency f the anti-symmetric train mode is 20 Hz, the gain ∥ΔP∥ is still 15 dB and the phase φ is −80°.

FIGS. 7 and 8 show the example of a restriction Kᵣ, placed upstream from the distributing valve, in order to correct the phase of the hydraulic amplifier, compared with FIGS. 5 and 6, when the frequency fₜᵣₐᵢₙ of the anti-symmetric train mode is 20 Hz. In FIGS. 7 and 8, when the frequency fₜᵣₐᵢₙ of the anti-symmetric train mode is 20 Hz, the gain μΔP∥ is 28 dB and the phase φ is −10°.

The positioning of restriction 20 determines the expansion 16 that must be taken into account for the flexible hoses (value of the parameter k). In other words, if maximal energy dissipation at the terminals of restriction Kᵣ is desired when the frequency f is equal to the anti-symmetric train mode fₜᵣₐᵢₙ, restriction 20 must be placed such that the parameter k -train, (expansion of the hoses observed upstream from the restriction is such that the pulsation

$${ω}_{p 1} = \frac{{K}^{′}}{k} with {K}^{′} = \frac{K ( {α}_{0} ) {K}_{r}}{K ( {α}_{0} ) + {K}_{r}} ,$$

meaning that it is much smaller than the frequency of the said mode, the lower limit being given by the acceptability of the power-assistance performance (absence of wall effect, insufficient dynamic). For example, the frequency ωₚ₁ of the pole is lower than the frequency fₜᵣₐᵢₙ by at least one decade.

As a general rule, that corresponds to having the maximum of flexible hose 16 upstream from restriction 20. Restriction 20, for example, is disposed immediately between high-pressure port 91 and line 11.

This condition guarantees that the dissipated energy depends only on the pressure difference ΔP between chambers 6a, 6b at the frequency fₜᵣₐᵢₙ of the anti-symmetric train mode and the chosen restriction Kᵣ.

In one embodiment of the invention, φ(fₜᵣₐᵢₙ)≧−20°.

In one embodiment of the invention, added restriction 20 increases the phase shift at the frequency fₜᵣₐᵢₙ the anti-symmetric train mode by at -train Of least 60°, or in other words with the correction applied by supplementary restriction 20 in FIG. 2 compared with the non-corrected case of FIG. 3.

1-10. (canceled)

11. A hydraulic actuating circuit for power-assisted steering for a motor vehicle, comprising:
at least one steering-control inlet and at least one hydraulic-fluid outlet, the outlet to apply a hydraulic-fluid pressure to a hydraulic cylinder for power-assisted steering to actuate a vehicle steering train in communication with the cylinder as a function of a steering control signal received at the inlet;
a pressurized hydraulic-fluid supply pump;
at least one first high-pressure hydraulic-fluid line and at least one second hydraulic-fluid line;
a hydraulic-fluid distributing valve including first and second hydraulic-fluid supply ports in communication with the pump via the first and second lines respectively, and at least one supplementary port, which is in communication with the outlet, the valve being provided, between the supplementary port and the first or second port, with a hydraulic-fluid passage cross section that is variable as a function of a control signal present at the inlet; and
restricting means for restricting the hydraulic-fluid passage cross section of the pump toward the first port provided on the first high-pressure line,
wherein, for a steering train having a dynamic whose first order corresponds to a first anti-symmetric train mode, with a given specific frequency, the restricting means is chosen such that the transfer function of the pressure of the outlet relative to the control signal at the inlet has a zero whose frequency is below the specific frequency of the first anti-symmetric train mode.

12. A hydraulic actuating circuit for power-assisted steering according to claim 11, wherein the restricting means includes a localized element for restricting the passage cross section of the first high-pressure line upstream from the first port of the valve; and
the first high-pressure line comprises a flexible hydraulic-fluid hose having an expansion volume larger than a stipulated value between the restricting element and the pump.

13. A hydraulic actuating circuit for power-assisted steering according to claim 12, wherein the restricting element is interposed between the outlet end of the first high-pressure line, distant from the pump, and the first port of the valve.

14. A hydraulic actuating circuit for power-assisted steering according to claim 11, wherein, for a steering train having a dynamic whose first order corresponds to a first anti-symmetric train mode, with a given specific frequency, the restricting means is chosen such that the transfer function of the pressure of the outlet relative to the control signal at the inlet has a total phase shift of less than 20° in absolute value at the specific frequency of the first anti-symmetric train mode.

15. A hydraulic actuating circuit for power-assisted steering according to claim 12, wherein, for a steering train having a dynamic whose first order corresponds to a first anti-symmetric train mode with a given specific frequency, the restricting means adds for the specific frequency of the first anti-symmetric train mode a positive value to the phase shift of the transfer function of the pressure of the outlet relative to the control signal at the inlet.

16. A hydraulic actuating circuit for power-assisted steering according to claim 15, wherein the added positive value of phase shift of the restricting means is greater than or equal to 60° at the specific frequency of the first anti-symmetric train mode.

17. A hydraulic actuating circuit for power-assisted steering according to claim 12, wherein the restriction is calibrated at a given value.

18. A hydraulic actuating circuit for power-assisted steering according to claim 12, wherein the frequency of the zero of the transfer function is equal to one third of the specific frequency of the first anti-symmetric train mode.

19. A hydraulic actuating circuit for power-assisted steering according to claim 12, wherein, for a double-acting cylinder, a first outlet is provided to apply a hydraulic-fluid pressure on a first side of a piston of the cylinder and a second outlet is provided to apply a hydraulic-fluid pressure on a second side of a piston of the cylinder opposite the first side,
the valve includes:
a third port in communication with the first outlet,
a fourth port in communication with the second outlet,
a first branch for passage of hydraulic fluid, associated with a first passage cross-section restriction between the third port and the first port,
a second branch for passage of hydraulic fluid, associated with a second passage cross-section restriction between the third port and the second port,
a third branch for passage of hydraulic fluid, associated with a third passage cross-section restriction between the fourth port and the first port, and
a fourth branch for passage of hydraulic fluid, associated with a fourth passage cross-section restriction between the fourth port and the second port,
the hydraulic-fluid passage cross section of the first and fourth restrictions or the hydraulic-fluid passage cross section of the second and third restrictions being a function of the control signal present at the inlet.

20. A motor vehicle, comprising:
a steering wheel connected via a steering column to a rack for controlling displacement of the rack connected to a steering train so as to orient guiding wheels connected to the train, the rack being connected to at least one hydraulic cylinder for assisting displacement of the rack;
a hydraulic circuit for actuating the power-assisted steering according to claim 12; and
means for applying, as a function of rotation of the steering column, a steering control signal at the inlet of the hydraulic circuit for actuating the power-assisted steering,
the cylinder being in communication with the outlet of the hydraulic actuating circuit to receive therefrom a hydraulic-fluid pressure for actuating the cylinder with a view to displacing the rack according to the steering control signal.
